(19) United States
(12) Patent Application Publication
(10) Pub. No.: US 2020/0141320 A1
(43) Pub. Date: May 7, 2020

(54) COMPENSATION DEVICE FOR COMPENSATING THERMAL RELATIVE MOVEMENTS

(71) Applicant: MAN Energy Solutions SE, Augsburg (DE)

(72) Inventors: Steffen BRAUN, Augsburg (DE); Daniel Albrecht, Augsburg (DE); Harald Denkel, Baar (DE); Stefan Weihard, Augsburg (DE); Bernd Haas, Neusäss (DE); Johannes Niebuhr, Augsburg (DE); Urban Spatz, Neusäss (DE)

(21) Appl. No.: 16/674,603

(22) Filed: Nov. 5, 2019

(30) Foreign Application Priority Data
Nov. 7, 2018 (DE) 102018127719.9

(51) Int. Cl. F02C 7/20; F01D 25/14

(52) U.S. Cl. CPC F02C 7/20; F01D 25/14

(57) ABSTRACT

A compensation device for two interconnected components arranged for the axial and radial compensation of thermally induced expansions of the two components between the two components and includes a central connecting portion for mechanically connecting to the first component and a plurality of connecting portions for connecting to the second component, which are connected to the central connecting portion in one piece. The connecting portions are at least partly formed offset relative to the connecting portion in an axial direction.

### BACKGROUND OF INVENTION

### 1. Field of the Invention

The invention relates to a compensation device for the axial and radial compensation of thermally-induced expansions of the two components that are connected or are to be connected to one another, in particular components of a turbomachine, wherein the compensation device, is arranged between the two components.

### 2. DESCRIPTION OF RELATED ART

In mechanical connections of components that are connected to one another in a moving and thermally-loaded device, which exhibit different expansions during the operation of the device, be it because of different expansion coefficients of the components concerned and/or because of different thermal loads, various problems regarding the mechanical loading of the connecting points and the vibration behaviour arise. Conventional connecting elements make possible a connection of adjoining components that are stiff in terms of vibration but are regularly disadvantageous or even unsuitable for the compensation of thermal deformations. Through the occurrence of thermal expansions, deformation forces are created which can result in the failure of the components.

The publication DE 1020 12112 432 A1 relates to a bracket device for attaching an exhaust gas turbocharger to an internal combustion engine, with a first bracket element, which is assigned to an internal combustion engine, and a second bracket element, which is assigned to an exhaust gas turbocharger.

In order to decouple the exhaust gas turbocharger from the vibrations of the internal combustion engine, the same is frequently fixed on the engine via a bracket device. Such a bracket can serve for the compensation. A plurality of solutions in this regard are known in the prior art. However, such brackets are generally designed for vibratory optimisation, but have not shown any satisfactory characteristics for compensation based on thermal influences. Furthermore, the solutions known in the prior art are not scalable in their characteristics so that an adaptation of the compensation characteristics dependent on the thermal peripheral conditions can take place in an easy and cost-effective manner.

### SUMMARY OF THE INVENTION

One aspect of the invention is overcoming the aforementioned disadvantages and providing a solution that can be cost-effectively produced and universally adapted in order to satisfactorily decouple two interconnected components, in particular two components of a turbomachine.

The basic idea of one aspect of the invention is a flexible compensation device arranged as a connecting element between two components, which differ in their thermal expansion behaviour, wherein a feature of the flexible connecting element is the specific configuration of the same, which makes possible a kind of “stiffness adjustability”.

The flexible compensation device in terms of design provides in a first assembly plane a first connecting element and in a second assembly plane a second connecting element (or a plurality of such connecting elements), wherein the second assembly plane is offset in an axial direction relative to the first assembly plane. Such a configuration makes possible compensating thermally-induced expansions both in the radial and also in the axial direction, i.e. in directions that are orthogonal to one another.

According to one aspect of the invention, a compensation device for two components that are connected or to be connected to one another, in particular components of a turbomachine is provided, wherein the compensation device is configured for the axial and radial compensation of thermally-induced expansions of the two components and is arranged between the two components and comprises a central connecting portion for mechanically connecting to the first component and a plurality of connecting portions for connecting to the second component, which are formed in one piece with the central connecting portion, wherein the connecting portions are at least partly arranged offset relative to the connecting portion in an axial direction.

In a preferred configuration it is provided that the central connecting portion comprises a plurality of connecting elements to connect the first component to the same by connecting elements or screws.

In a configuration for the compensation between a burst protection device of the turbomachine and a turbine inflow housing that is advantageous for turbo machines it is provided that the central connecting portion is designed as a disc-shaped annular portion or an annular disc element.

Further advantageous is an embodiment, in which the connecting elements are formed as openings or holes in the central connecting portion in order to realize, by conventional connecting elements such as for example screws, a connection to the first component or to the turbine inflow housing.

In a preferred embodiment of the invention it is provided, furthermore, that the connecting portions of the compensation device are each formed at the end by retaining arms that are at least bent over by way of a step or slope or fold or double-folded. By way of such a configuration, a plurality of circumferential holding straps for fastening the second component or the burst protection device can be realised.

The axial stiffness of the compensation device is adjusted by the quantity of the retaining arms or straps, their length, their material thickness, and their retaining arm width. Besides the material thickness and the retaining arm width, the radial stiffness is also adjusted by way of the geometry parameters of the fold or the step. By way of the stepped connection, a greater or lower radial stiffness can be achieved depending on the step characteristic.

Through the suitable selection of the concrete configuration of the retaining arms, the desired stiffness can be adjusted with the objective of avoiding impermissible constraining forces through expansion obstructions and permit at the same time adequately high natural frequencies of the vibrating overall system.

Here it is likewise advantageous when the retaining arms form a strap-like fastening portion with which the respective retaining arm is connected to the connecting portion, wherein the fastening portion is followed by a sloping portion or a step portion and the latter is followed by the respective connecting portion.

In a further advantageous configuration of the invention the retaining arms are arranged distributed over the circumference, preferentially at equidistant intervals and extend radially to the outside or (in a possible other embodiment) radially to the inside.

In a preferred embodiment it is provided, furthermore, that multiple or all connecting portions define a common assembly plane for connection to a connecting surface on the second component.

It is likewise advantageous when, viewed in the circumferential direction, a connecting portion each is arranged between every two connecting elements and an even distribution of the connecting elements has been selected altogether in the circumferential direction, so that the forces are likewise evenly steered.

A further aspect of the present invention relates to a turbomachine comprising a turbine inflow housing (as first component) and a burst protection device (as second component), wherein between the turbine inflow housing and the burst protection device a compensation device as described before is attached.

It is advantageous, furthermore, when for this purpose the turbine inflow housing is connected to the central connecting portion and the burst protection device to the connecting portions.

### BRIEF DESCRIPTION OF THE DRAWINGS

Other advantageous further developments of the invention are characterized in the subclaims or are shown in more detail by way of the figure in the following together with the description of the preferred embodiment of the invention.

It shows:

FIG. 1 is a perspective view of a compensation device according to the invention;

FIG. 2 is a lateral view of the compensation device according to FIG. 1; and

FIG. 3 is a plan view of a part of the compensation device according to FIG. 1.

### DETAILED DESCRIPTION OF THE PRESENTLY PREFERRED EMBODIMENTS

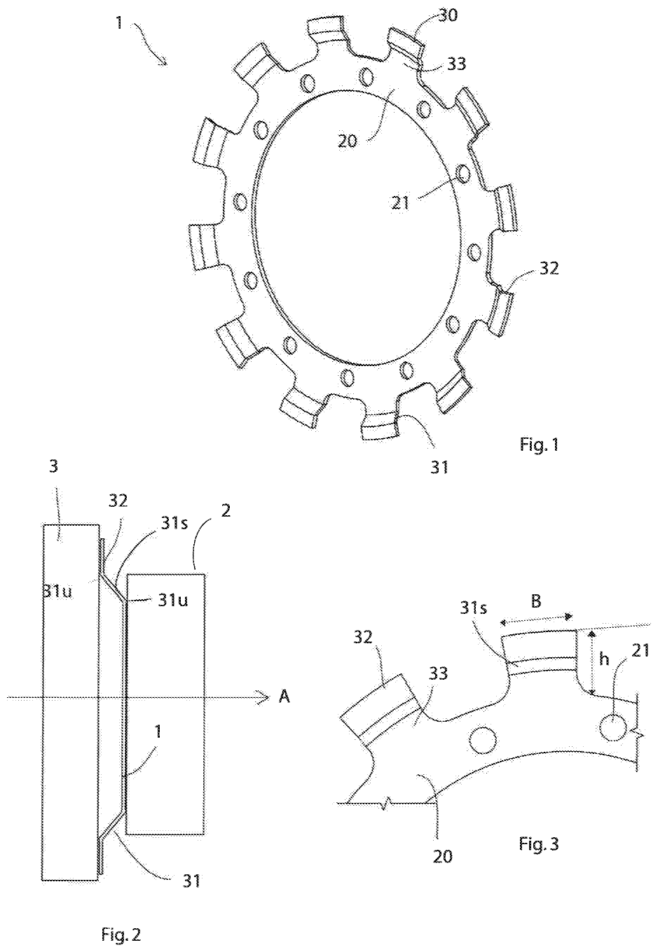

In the following, the invention is described in more detail with reference to the FIGS. 1 to 3, wherein same reference numbers relate to same functional and/or structural features.

In FIG. 1, a perspective view of a compensation device 1 according to one aspect of the invention is shown.

The compensation device 1 is designed to interconnect the merely schematically shown two components 2, 3, which in the present exemplary embodiment represent a turbine inflow housing 2 and a burst protection device 3.

For the axial and radial compensation of thermally induced expansions of the two components, the compensation device 1 is arranged between the two components 2, 3. The compensation device 1 comprises a central connecting portion 20 for the mechanical connection to the turbine inflow housing 2, wherein the same as disc-shaped annular portion is provided with 12 connecting elements in the form of openings 21, in order to attach the same to the turbine inflow housing 2 by screws.

Furthermore, 12 retaining arms 32 project from the disc-shaped annular portion 20, at the end of which in each case a connecting portion 30 for connecting to the burst protection device 3 is provided. As is clearly evident in the FIGS. 1 and 3, the connecting portions 30 are arranged offset relative to the disc-shaped annular portion 20 in the axial direction A.

To this end, the respective connecting portions 30 are each connected in one piece to the disc-shaped annular portion 20 by a double counter-folded step 31 via the fastening portion 33. The step 31 forms a sloping step portion 31s between the two folds 31u.

In the FIG. 2, the width B and the radial distance h between the end of the connecting portion 30 and the disc-shaped annular portion 20 are shown as exemplary parameters besides the slope of the sloping step portion 31s and the formation of the folds, in order to influence the stiffness of the retaining arms 32. Complementarily, the entire stiffness and thus the compensation characteristics of the compensation device 1 can be influenced via the choice of the material and the material thickness.

In the view according to FIG. 3 it is evident, furthermore, that the connecting portions 30 define a common assembly plane for connecting to a connecting surface on the burst protection device 3.

In its embodiment, the invention however does not restrict itself to the preferred exemplary embodiments stated above. On the contrary, it is conceivable that depending on the assembly situation the retaining arms for example can each be designed adapted to the assembly connection on the component with different length or slope position.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A compensation device for two interconnected components, configured for axial and radial compensation of thermally induced expansions of the two components and arranged between the two components comprising:
a central connecting portion configured to mechanically connect to a first component; and
a plurality of connecting portions configured to connect to a second component, which are connected to the central connecting portion in one piece,
wherein the plurality of connecting portions are at least partly designed offset in an axial direction relative to the central connecting portion.

2. The compensation device according to claim 1, wherein the central connecting portion comprises a plurality of connecting elements configured to connect the first component by connecting elements.

3. The compensation device according to claim 1, wherein the central connecting portion is a disc-shaped annular portion.

4. The compensation device according to claim 2, wherein the connecting elements are formed as one of openings and holes in the central connecting portion.

5. The compensation device according to claim 1, wherein the plurality of connecting portions are each formed at an end by retaining arms that are one of bent over via at least one step and folded.

6. The compensation device according to claim 5, wherein the retaining arms are distributed over a circumference at equidistant intervals and extend one of radially to an outside and radially to an inside.

7. The compensation device according to claim 5,
wherein the retaining arms form a fastening portion, with which a respective retaining arm is connected to the central connecting portion, and
wherein the fastening portion is followed by a sloping step portion and the sloping step portion by the respective connecting portion.

8. The compensation device according to claim 1, wherein multiple or all connecting portions define a common assembly plane for connecting to a connecting surface on the second component.

9. The compensation device according to claim 2, wherein viewed in circumferential direction a respective connecting portion is arranged between each two connecting elements.

10. A turbomachine comprising:
a turbine inflow housing;
a burst protection device; and
a compensation device arranged between the turbine inflow housing and the burst protection device comprising:
a central connecting portion configured to mechanically connect to a first component of the turbine inflow housing and the burst protection device; and
a plurality of connecting portions configured to connect to a second component of the turbine inflow housing and the burst protection device, which are connected to the central connecting portion in one piece,
wherein the plurality of connecting portions are at least partly designed offset in an axial direction relative to the central connecting portion.

11. The turbomachine according to claim 10, wherein the turbine inflow housing is connected to the central connecting portion and the burst protection device is connected to the plurality of connecting portions.

12. The compensation device according to claim 1, wherein the two interconnected components, are parts of a turbomachine.

13. The compensation device according to claim 2, wherein the connecting elements are screws.
